(19) United States
(12) Patent Application Publication
(10) Pub. No.: US 2013/0212126 A1
(43) Pub. Date: Aug. 15, 2013

(54) Method and Apparatus for Conducting a Search

(71) Applicants: Konstantinos Papamiltiadis, London (GB); Jake Turner, Papworth Everard (GB); Simon Rodgers, Ely (GB); Chris Porter, Bury St Edmunds (GB)

(72) Inventors: Konstantinos Papamiltiadis, London (GB); Jake Turner, Papworth Everard (GB); Simon Rodgers, Ely (GB); Chris Porter, Bury St Edmunds (GB)

(73) Assignee: TAPTU LTD., Cambridge (GB)

(21) Appl. No.: 13/588,150

(22) Filed: Aug. 17, 2012

Related U.S. Application Data
(60) Provisional application No. 61/525,936, filed on Aug. 22, 2011.

(51) Int. Cl. G06F 17/30

(52) U.S. Cl. CPC G06F 17/30864
USPC 707/770

(57) ABSTRACT

The invention describes a query server and a computer-implemented method to provide a search service for finding online content. The query server may be incorporated in a system to provide the search service.

A search query is received from a user and a set of sources of online content associated with said user is identified. The search query is output to said identified set of sources to generate search results from within said identified set of sources. The search results are then sent to said user.

### FIELD OF THE INVENTION

This invention relates to query servers for providing a mobile search service, to corresponding methods of using a mobile search service, and corresponding apparatus and software.

### BACKGROUND ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

Known Internet search engines take a query from a user and return a list of search results. A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance.

For all search engines, the order that results are displayed will depend on many factors, but are typically derived from at least a measure of how well the search terms matched the candidate documents and some measure of the significance or popularity of those documents independent of the search terms. For example, it is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank™ is a static ranking of web pages used as the core of the search engine known by the trademark Google (http://www.google.com).

The present applicant has realized that further improvements are possible, particularly to address searches based on keywords within a certain context.

### SUMMARY OF THE INVENTION

The invention describes a query server and a computer-implemented method to provide a search service for finding online content. The query server may be incorporated in a system to provide the search service.

A search query is received from a user and a set of sources of online content associated with said user is identified. The search query is output to said identified set of sources to generate search results from within said identified set of sources. The search results are then sent to said user.

On traditional search engines, the user cannot specify either the:
specific sources from where the articles displayed will come (not just domain or class of sites)
the topic/genre of the sources/articles to be displayed

The invention provides a double filtering of search results, a filter by the search query (which may be in the form of a keyword/phrase) and a second filter by sources or topic/genre. By having a user defined set of multiple sources, the invention may also provide granularity of searching as described in more detail below. The search is also personalised to a user.

The search results sent to the user may be a visual feed, also known as stream, comprising stories or other material. The results may be arranged in chronological order. The set of sources may be termed a smart stream. The set of sources may be associated with a keyword or search term as well as the user. In this case, the set of sources may be termed a smart search stream.

The system may comprise a database to which the query server is connected (directly or indirectly, e.g. via a stream store). The database may store sets created on a previous occasion by said user. The identification of the set of sources may thus be simply a user selecting one of these sources.

Alternatively, the user may be prompted to define the sources to identify the sources to be used. For example, the user to define the set of sources by specifying one of more of the following:
1. sources selected from a comprehensive set of sources (i.e. BBC News, CNN World, etc)
2. a subset of the comprehensive sources, the subset being recommended by the system which may be termed as Tags and may be related to certain Topics/Genres (Politics, World Affairs, Business, Technology, etc)
3. sources which a user has previously grouped together under a certain user supplied Tag (i.e. John's Politics, or Fred's Legal Stream, etc), these may be terms Mixed streams
4. All of the above
5. None specified

The system may further comprise a user interface to which the query server is connected (directly or indirectly, e.g. via the web server and internet). The sources from a user which may define the user associated set of sources may be displayed on the user interface and the user interface sends a message to the query server when a source has been selected or deselected.

After the search results are output to the user, the search may be further refined by adapting the user associated set of sources. The choice of sources may be displayed to the user as described above and a user may select another source for inclusion in the user associated set of sources. The search query may then be sent again to the new user associated set of sources and a new set of search results be sent to the user. In other words, the double filtered search may be iteratively refined by the user. At each iteration, the user may opt to store the new user associated set of sources thus creating several different smart streams.

Once the user has received the search results, the user can scroll through those stories and consume content coming from the previously defined sources.

It will be appreciated that the order of receiving the search query and identifying the set of sources is not critical and can be reversed to achieve the same double filtering.

As an alternative, a list of sources may be sent to a user for selection and a selection of at least one source from within said list of sources may be received to create a selected set of sources. The search query may then be received from a user. The search results are generated from within said selected set of sources, and output said to said user. As previously described, the search results may be iteratively refined by the user.

The invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C, or assembly code. As the skilled person will appreciate such code and/or data may be distributed between a plurality of coupled components in communication with one another.

### BRIEF DESCRIPTION OF THE DRAWINGS

The invention is diagrammatically illustrated, by way of example, in the accompanying drawings, in which:

FIG. 1a is a schematic block diagram of the components of the system;

FIG. 1b is a flowchart of a method for conducting a search using the system of FIG. 1a;

FIG. 2a is a screenshot of a user device for creating a smart stream from existing streams;

FIG. 2b is a screenshot of the device of FIG. 2a after the smart stream has been selected;

FIG. 2c is a flowchart of one method of creating a smart stream;

FIG. 3a is a screenshot showing search results returned following a key word search;

FIG. 3b is a screenshot showing the first step in creating a smart stream from existing streams;

FIGS. 3c to 3e show alternative streams available in a service defined suggestion list, a user defined list and the full store;

FIG. 3f is a flowchart of another method of creating a smart stream;

FIG. 4 shows a screenshot with merged streams

### DETAILED DESCRIPTION OF THE DRAWINGS

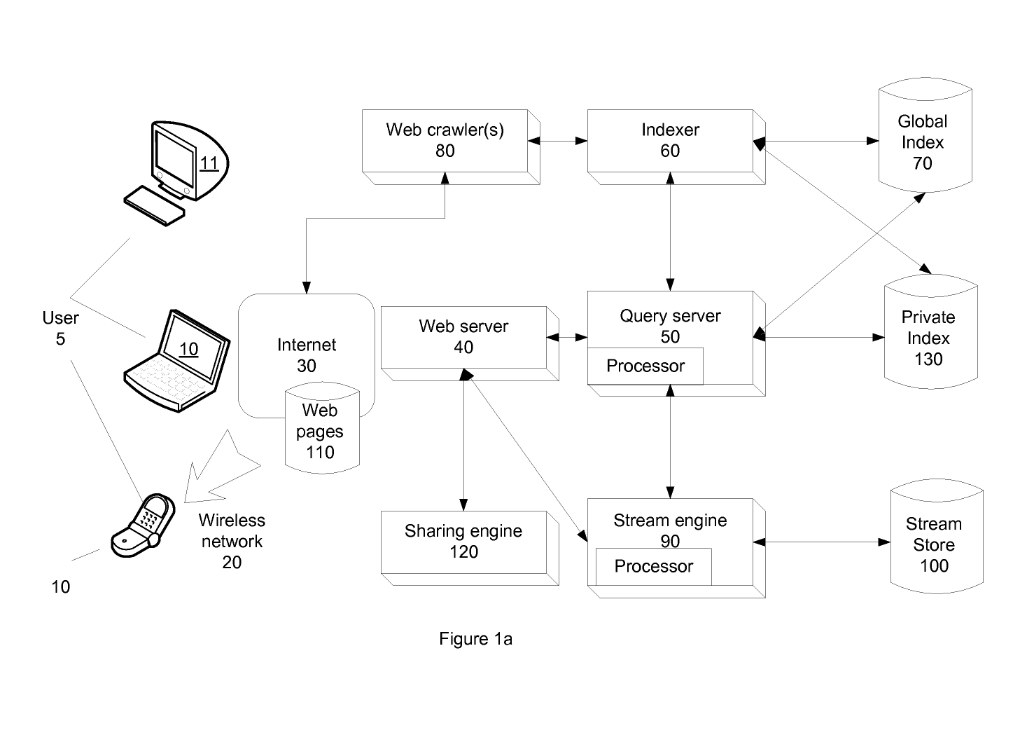

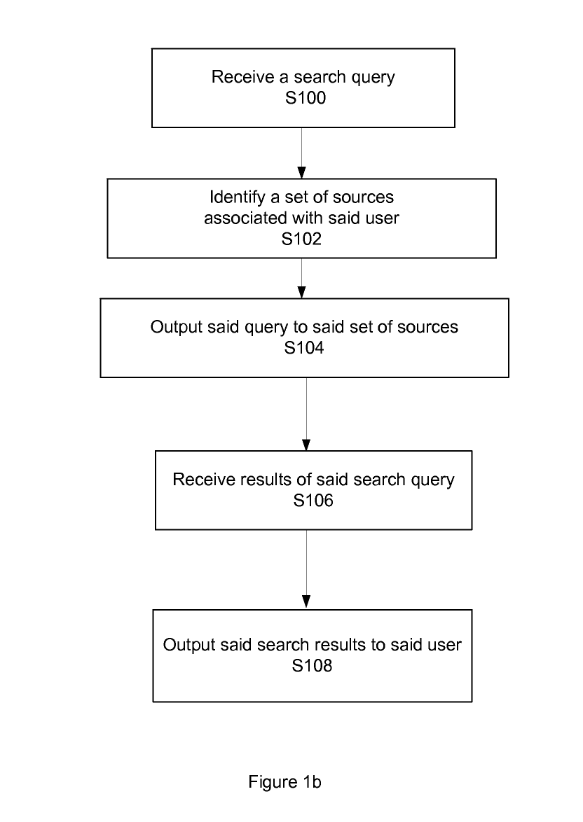

The overall topology of the embodiments of the invention is illustrated in FIG. 1 which shows a mobile search service deployed using the normal components of a search engine. The search engine service is deployed using the query server 50 to prompt for and respond to queries from users. The indexer 60 populates the global index 70 and private index 130 containing word occurrence lists (commonly referred to as inverted word lists) together with other meta-data relevant to scoring. The back-end crawler 80 scans for and downloads candidate content (“documents”) from the web (or other source of indexable information). This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device.

The documents fetched and supplied to the indexer 60 can be of numerous different types, e.g. images, audio files, wikipedia™ pages.

A stream engine 90 and connected stream store 100 form part of the system. In the Figure they are shown as connected to the web server 40 and the query server 50 but they may be connected to other components within the system. In this context, a stream is a visual feed or source which provides a plurality of articles or stories. For example, a stream may be a website, e.g. a news site such as www.bbc.co.uk. The stream store 100 stores a plurality of different database of sources. There are databases which comprise a user defined set of sources (also known as Mixed Streams) that are grouped under a user tag so that they are associated with a particular user, components of those sources make up the Private index 130. Thus although the private index 130 and the stream store are shown as separate databases, they may be combined within one database. There are also databases comprising a set of sources defined by the system provider. These databases may be grouped by topic, e.g. politics, world affairs, business or technology. The global index 70 may form part of these system provider defined databases.

An optional component is a sharing engine 120 which allows a user to share or publish the smart search stream that has been created. The sharing engine may have one or more databases to store registered users and streams of published search results. The publication (or sharing) of results could be achieved for example as set out in WO 2009/001140 to the present applicant. The publication may be private, e.g. by adding the results so that they are only visible to that user or as the limited publication to nominated users only (i.e. friends). Alternatively, publication may be public publication so that results can be viewed by any user whether identified (logged in) or not. For the group privacy implementation, the concept of user's friends is added. Friends are declared by a user thus enabling those declared user's access to view items published as private.

Sharing may be achieved by the following steps:
User clicks on the sharing button of the Search Stream
User selects whether to share the stream via:
   Facebook
   Twitter
   Linkedin
   Email
Appropriate dialogue window opens
A tpt.to URL is generated for the Search Stream and posted as per the options selected above

FIG. 1b outlines the main steps of a method of conducting a search using the system above. The first step S100 is receiving a search query from a user. The search query is typically input by a user on a user interface on the user's device, e.g. by typing into a keyboard. The search query is received by the query server 50, e.g. via the web server 40 as shown in FIG. 1a. The next step S102 is to identify a set of sources of online content (i.e. a smart search stream) associated with said user. This is typically done by the query server, e.g. within its processor. Alternatively, this step may be carried out by another component, e.g. the stream engine 90. The identification may simply be receiving an identification of the set of sources from the user, i.e. the user selects a previously created smart stream to be used. Alternatively, the identification may be as described in more detail below to iteratively update the set of sources in realtime in response to the search results.

Once the set of sources have been identified, the search query is output to said set of sources at step S104. This may be achieved by the query server itself or by a back end engine connected to the query server. For example, the query server may send the query and the identified set of sources to the indexer 60 which together with the web crawler 80 searches the Internet within the identified set of sources. The results of the search query may be received by the query server at step S106 and transmitted to the user at step S108. Alternatively, the outputting of the search results may be arranged without the need for the search results to be transmitted to the query server.

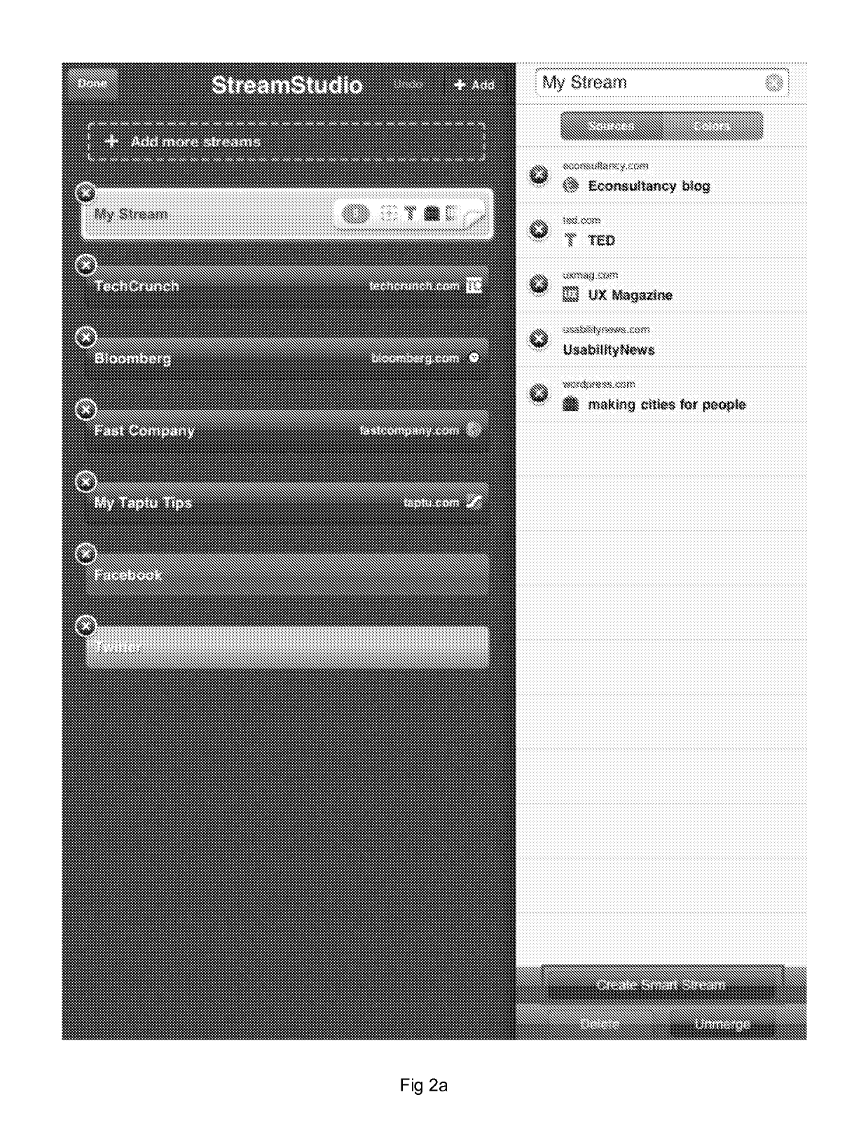

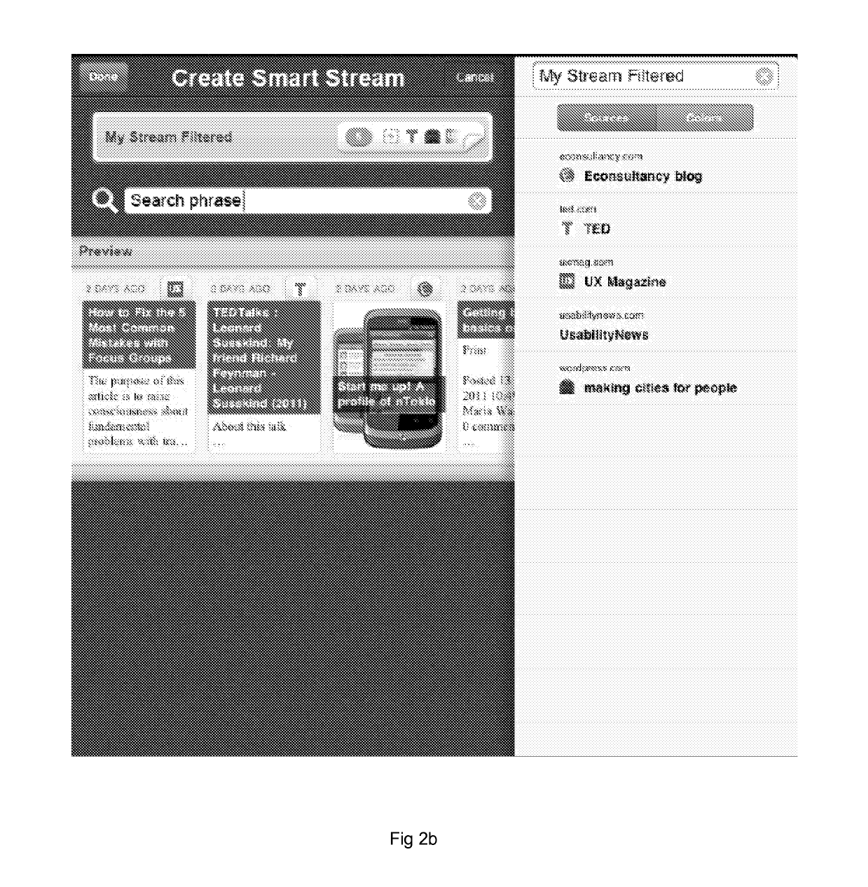

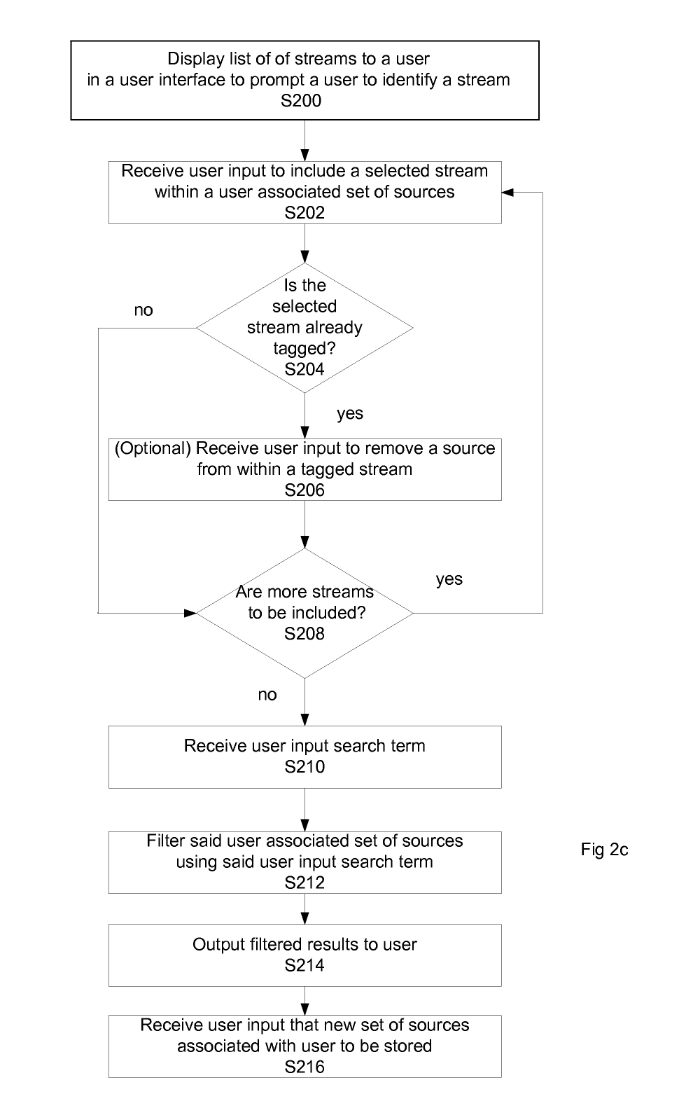

The creation and editing of smart search streams is described in more detail with reference to FIGS. 2a to 5b. The aim of a smart search stream is to allow a user to filter search results. The filtering can be done by specifying which sources or streams (feeds) are to be included in any search. These streams can be termed as tagged sources. A second filter layer can be added by specifying a search keyword, e.g. Obama. Alternatively, a user can start with a keyword and filter the search by specifying which streams to include. The streams to be included (i.e. tagged) may be selected from predetermined user lists, recommendations and/or a full search of all available source.

FIGS. 2a to 2c show how a smart search stream can be created from an existing stream and filtered by keyword. FIG. 2a shows an example user interface in the form of a screenview on a mobile device showing a streamstudio which lists the available streams which could be included in a search query. The list included a stream entitled “my stream” which includes the user defined set of sources. By clicking on the button marked “my stream”, a user can view the complete list of sources in “my stream” which are displayed on the right of the screen. Each stream is associated with a name, e.g. “TED” or “usabilityNews” and/or a colour both of which can be set by the user. A plurality of other streams are also listed as suggestions for a user to include in the current search.

As shown in FIG. 2c, the first step S200 in creating a list of sources to be used in the search, i.e. to create a “smart stream”, is to display a list of streams to a user in a user interface. The next step S202 is to receive user input to include a selected stream within a user associated set of sources. The user input may be in the form of the user selecting the stream(s) from the stream studio and clicking on “create smart stream” button at the bottom of the screen. In this example, the user has selected “my stream” which is a tagged stream. Thus as shown at step S204, the next step is to determine whether or not the stream is tagged and if so, optionally allow a user to remove one or more feeds from within said stream at step S206.

The next step is to determine whether or not any more streams are to be included. This may be done simply by a user clicking on the “add more streams” button on the user interface if they wish to add more streams. The method then loops back to the first step.

Once a user is finished, they click on “done” or “create smart screen” to finish the process. The next step is for a user to input a search term. Accordingly, the user is now presented with a search screen having a window or text box in which to input a search term as shown in FIG. 2b. A preview of the stream is also shown in a preview pane.

The user enters a keyword into the text box (step S210) and the preview of the stream is updated with articles matching the keyword (in other words the original user associated set of sources is filtered using said user input search term at step S212). The results are output to the user at step S214, for example, they are listed chronolocigally. The user can then click on “done” to save the stream, i.e. to input that they wish to be associated with this new set of sources (step S216). This creates a new smart stream which is linked to the keyword. In other words, the newly created smart search stream is a filtering of the existing smart stream (in this case the “my stream” by keyword.

In summary, the steps are:
User selects the “streamstudio”
Select a Feed or a Tag
Click on the button: Create Smart Stream
Text box to enter a keyword is displayed as well as a preview of the stream
Enter keyword and preview is updated with article matching the keyword
Save stream and a new stream is added

As an alternative, if the original stream is a Tag, user can remove constituent feeds from the search stream while changing the keyword.

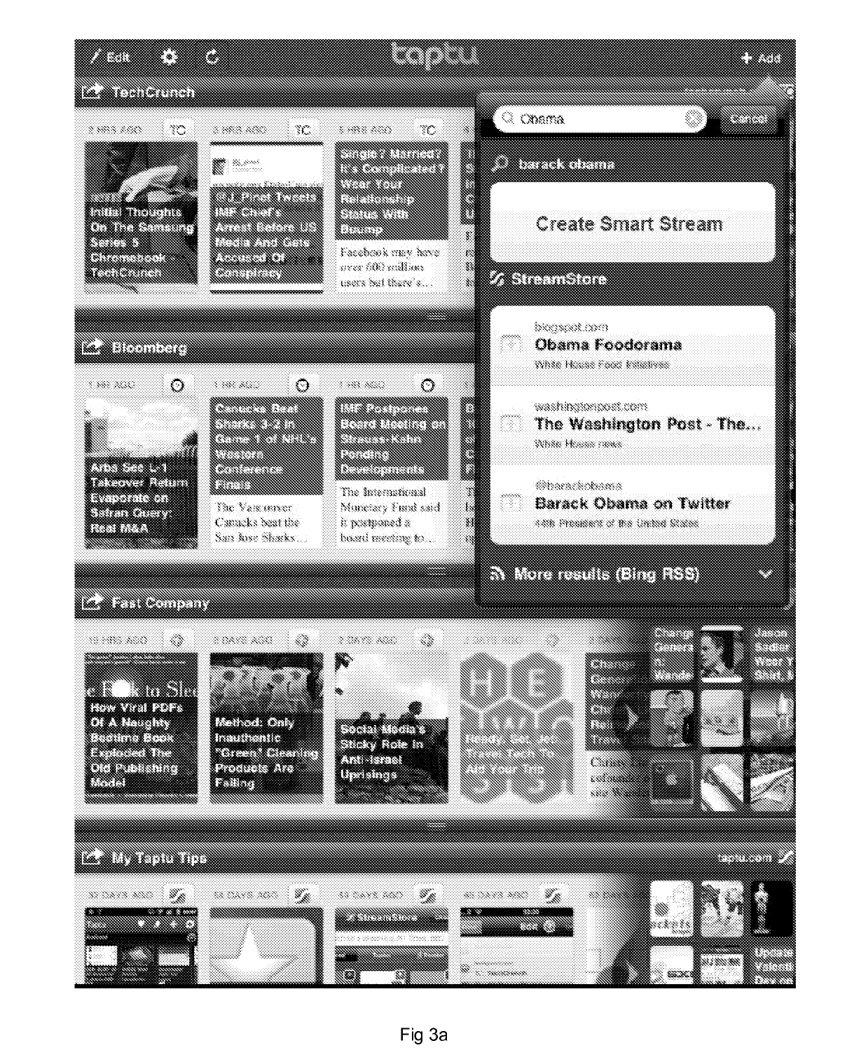

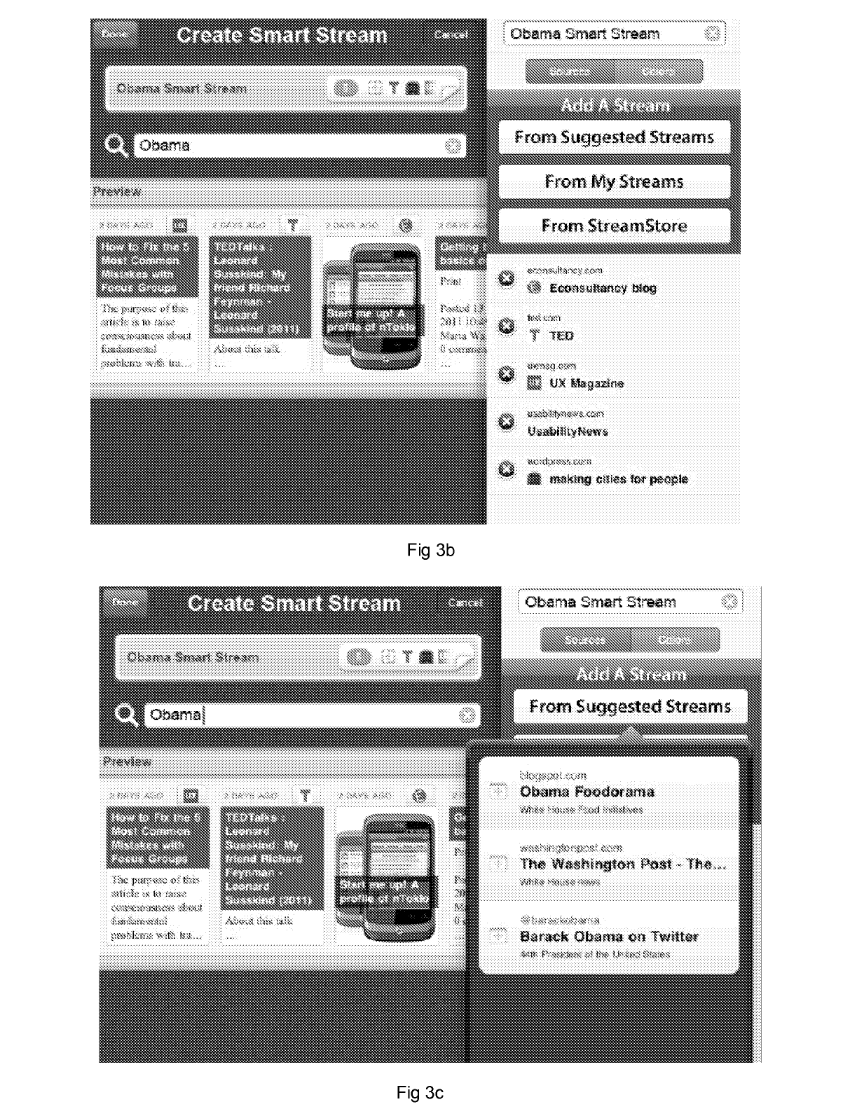

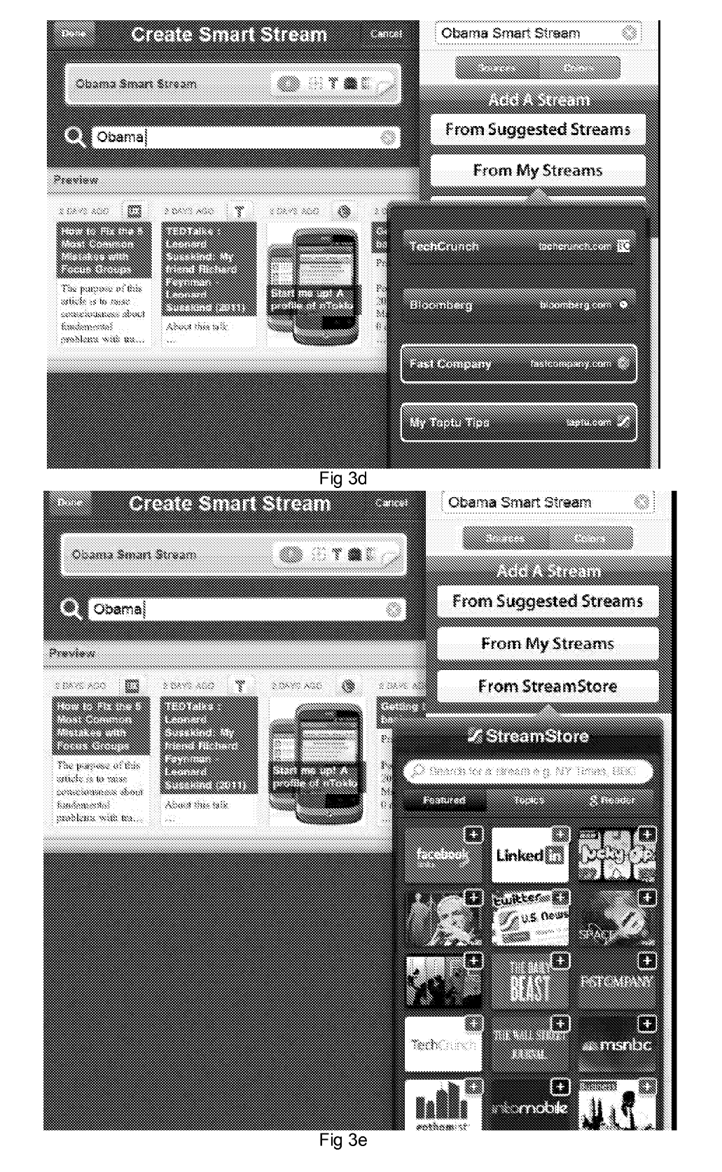

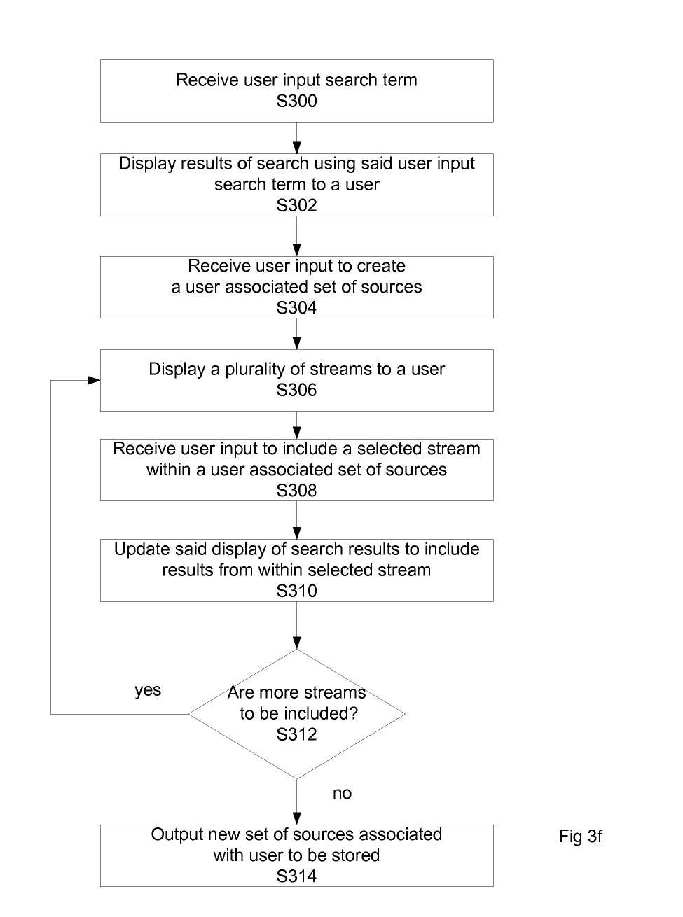

As an alternative, a user can create a smart search stream from the beginning as shown in FIGS. 3a to 3f. FIG. 3f summarises the steps in the method which is generally similar to that of FIG. 2c with the ordering of some steps reversed. Thus, in this case, the first step is for the user to input a search keyword, in this case Obama (step S300). The user is then presented with many articles from a variety of sources, e.g. from TechCrunch, Bloomberg, Fast Company as shown in FIG. 3a. These articles are the results of the search using the input search term. The user is presented with the option to create smart stream. Clicking on this button (step S304) takes a user to FIG. 3b in which the user is presented with three options for adding a stream (step S306), namely from streams suggested by the service provider, streams from a set defined by the user or from the full set of available streams in the stream store, i.e. a comprehensive set of sources.

FIG. 3c shows some example streams in the set suggested by the service provider. By clicking on the button marked with a “+”, a user can add the individual suggestions to the smart stream (step S308). FIG. 3d shows the streams in a user's predefined group. Each stream can be selected or deselected for the new smart stream. In FIG. 3d, the Fast Company and Taptu Tips streams are selected as shown by the highlight around each box and the other two streams are deselected for this Obama smart stream. In FIG. 3e, the user is presented with multiple streams which can be selected by clicking on the button marked with a “+”. There is also a text box in which a user can search for particular streams. Thus the user has access to all streams.

In each of FIGS. 3b to 3e, a preview of the search results which are returned by the smart search stream is shown in a preview pane (step S310). The results are listed chronologically. The next step is to determine whether or not any more streams are to be included (step S312). The system then loops back and repeats various steps. Any changes to the smart search stream, e.g. to add or remove streams, will be reflected in the preview pane. Once a user is happy with the smart search stream, they can input to the system that the process is complete and the new set of sources (i.e. new smart stream) is output, e.g. to the stream store, for later access.

In summary, the steps are:
User searches on the StreamStore
Option to add three types of Smart Search Stream are displayed
   Add Smart Search Stream from Suggested streams: list of streams that have more than one story related to the keyword or
   Add Smart Search Stream from My Streams: list of all streams that have been added/curated by the user or
   Add Smart Search Stream from full list available in stream store
User selects any or all of the available streams and adds them to the smart search stream

Once a smart search stream has been created, it may also be edited. This may be done via a user interface such as the one shown in FIG. 2a, ie. through the “stream studio”. Each of FIGS. 3a to 3e also shows a text box in which the search term “obama” is displayed. A user can change the keyword while editing the stream by typing into the keyword text box.

The smart search stream may be edited by changing the keyword, e.g. changing Obama to US. For example, this may be achieved by the following steps:
User selects a Smart Search Stream and clicks on the Edit button
User is displayed with the previously set keyword for the particular stream
User enters a new keyword on the text box and stream preview is updated with the results for the new keyword
User can change the name of the streams if he/she likes at this stage as well select a colour of the stream, etc

Alternatively, the smart search stream may be edited by adding or removing Constituent Feeds/Tags. For example, this may be achieved by the following steps:
User selects a Smart Search Stream and clicks on the Edit button
User is displayed with the list of all the constituents feeds for this stream
User can add streams from three places
   Suggested streams: list of streams that have more than one story related to the keyword
   My Streams: list of all streams that have been added/curated by the user
   StreamStore: list of all the streams curated by Taptu
Every time the user selects to add a Tag, the list of constituent feeds for this tag are displayed on the list of constituent feeds for the Search Stream
User can also remove feeds from the list of constituents
Every time the user adds/removes a feed, the preview of stream gets updated

Alternatively, the smart search stream may be edited by merging Search Streams. For example, this may be achieved by the following steps:
User selects a Smart Search Stream and drops it inside another Search Stream
User is displayed with the list of all constituent feeds with the keyword for each of the search streams
User can change the colour of the new merged stream and name of it

Alternatively, this may be achieved by the following steps:
User selects a Smart Search Stream and drops it inside a Feed or a Tag Stream
User is displayed with a list of all constituent feeds with the keyword and separately the list of Constituent feeds of the Tags or the Feed itself

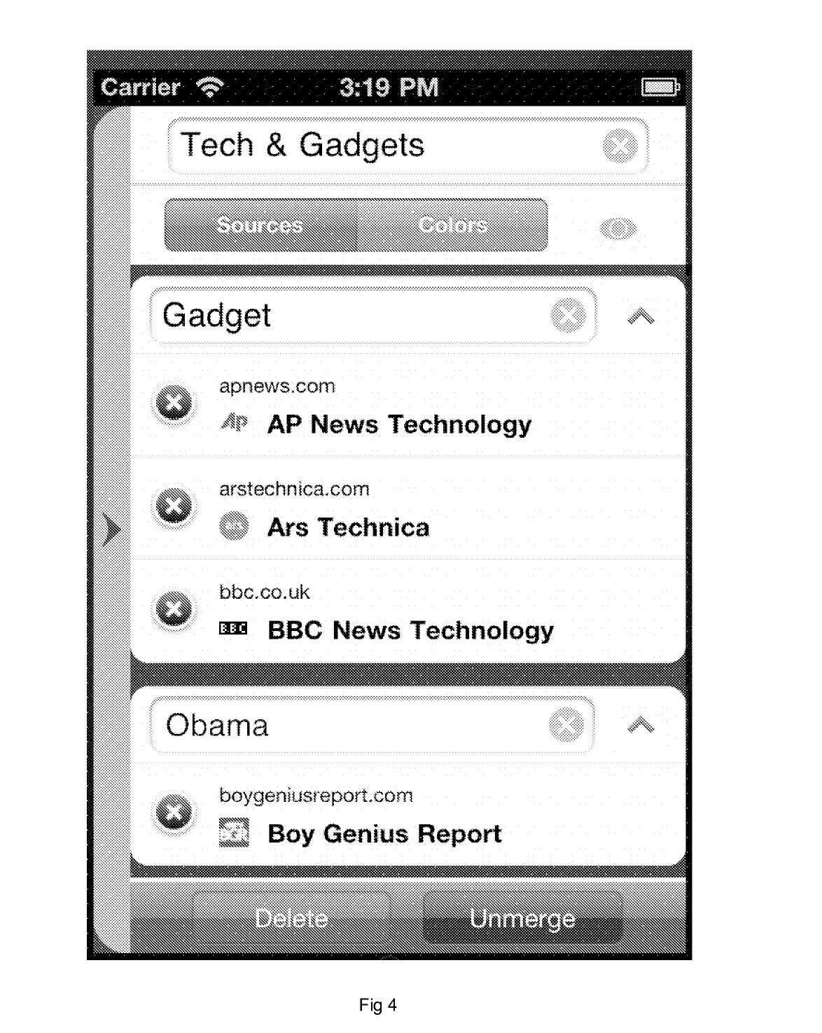

FIG. 4 shows a snapshot of a merged stream entitled “tech & gadgets” which combines both the obama and gadget search streams.

In all of the above embodiments, the search may be conducted on a mobile device which may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™, Mozilla™, browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

The query server may provide for user login. The user is identified by registering a username and password and then subsequently by logging in with the same username and password. The registration process is a one-time process per user. In a preferred embodiment, the login process is also a one-time process per user by caching their credentials (or a unique key representing their identity) in a cookie. However, where cookies are not supported then the user is required to provide username and password per result publication. The user could be required to login at the first page of the mobile search service, however, in the preferred embodiment, the user is only prompted for login (if not already identified) when first attempting to connect.

No doubt many other effective alternatives will occur to the skilled person. It will be understood that the invention is not limited to the described embodiments and encompasses modifications apparent to those skilled in the art lying within the spirit and scope of the claims appended hereto.

1. A query server to provide a search service for finding online content, the query server being arranged to
receive a search query from a user,
identify a set of sources of online content associated with said user,
output said search query to said identified set of sources to generate search results from within said identified set of sources, and
send said search results to said user.

2. A query server according to claim 1 which is connected to a database storing sets of sources associated with a user which were previously created by said user and which is arranged to identify the set of sources from said database by receiving identification of said set of sources from said user.

3. A query server according to claim 1 arranged to identify the set of sources by prompting the user to define the sources in response to receiving the search query.

4. A query server according to claim 3 arranged to prompt the user to define the sources from at least one of a comprehensive set of sources, a subset of sources selected by the query server and a set of sources which a user has previously grouped together.

5. A query server according to claim 1 arranged to identify the set of sources by prompting the user to define the sources prior to receiving the search query.

6. A query server according to claim 1 which is connected to a user interface on a user device whereby a plurality of sources are displayed on said user interface and said query server receives a user selection of at least one displayed source to be included in said identified set of sources.

7. A query server according to claim 6 whereby the plurality of sources comprises at least one of a comprehensive set of sources, a subset of sources selected by the query server and a set of sources which a user has previously grouped together.

8. A query server according to claim 6, wherein said user selection of at least one of said plurality of sources is received after said search results are output and said query server repeats said outputting and said sending steps.

9. A query server according to claim 1, wherein responsive to said sending said search results to said user, said query server is arranged to store in a database said identified set of sources together with said search query as a new set of sources associated with said user.

10. A query server to provide a search service for finding online content, the query server being arranged to
send a list of sources to a user for selection;
receive a selection of at least one source from within said list of sources to create a selected set of sources;
receive a search query from a user,
generate search results from within said selected set of sources, and
output said search results to said user.

11. A query server according to claim 11 responsive to said outputting said search results to said user, said query server is arranged to store in a database said selected set of sources together with said search query as a new set of sources associated with said user.

12. A query server according to claim 10 which is configured to receive a selection of at least one other source after said search results are output to said user and to repeat said generating and said outputting steps.

13. A computer-implemented method of providing a search service for finding online content, the method being implemented in a system comprising a query server, the method comprising
receiving, at a query server, a search query from a user,
identifying, using said query server, a set of sources of online content associated with said user,
outputting said search query to said identified set of multiple sources to generate a set of search results, and
sending search results to said user.

14. A carrier having processor control code thereon that causes a processor of said query server to carry out the method of claim 13.
